(19) United States
(12) Patent Application Publication
(10) Pub. No.: US 2011/0256439 A1
(43) Pub. Date: Oct. 20, 2011

(54) BATTERY FIXING APPARATUS AND ELECTRONIC DEVICE USING THE SAME

(75) Inventors: XIAN-WEI MA, Shenzhen City (CN); TING LUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/781,834

(22) Filed: May 18, 2010

(30) Foreign Application Priority Data
Apr. 14, 2010 (CN) 201010146692.2

(51) Int. Cl. H01M 2/10

(52) U.S. Cl. 429/97

(57) ABSTRACT

A fixing apparatus for fixing a battery in an electronic device is provided. The fixing apparatus includes a cover slidably disposed in an opening of the housing; a connecting portion connected to the cover via a first hinge; a transmission bar connected to the connecting portion via a second hinge; and a rotary portion rotatablely, defined in the housing, contacting with the transmission bar and the battery. When the cover closes the opening, the connecting portion is driven by the cover to arch and push the battery, and an electrode of the battery connects to the electrode connector. When the cover opens the opening, the connecting portion is driven by the cover to push the transmission bar, the rotary portion is pushed by the transmission bar to rotate, and the rotary portion pushes the battery to eject from the compartment via the opening.

### BACKGROUND

1. Technical Field

The disclosure relates to a fixing apparatus for fixing a battery in an electronic device.

2. Description of the Related Art

A portable electronic device, such as a mobile phone, an e-reader, or a notebook computer, often includes a compartment for accommodating a battery and a cover for closing the battery in the compartment. However, when removing the battery, a user must open the cover first, and then take the battery out from the compartment; when installing the battery, a user must insert the battery into the compartment, and then close the cover. As a result, such operations may be inconvenient for users.

Therefore, what is needed is a battery fixing apparatus which can simplify the process of replacing a battery.

### BRIEF DESCRIPTION OF THE DRAWINGS

The components in the drawings are not necessarily drawn to scale, the emphasis instead being placed upon clearly illustrating the principles of an electronic device with a battery fixing apparatus. Moreover, in the drawings, like reference numerals designate corresponding parts throughout the several views.

FIG. 1 is an isometric view of an electronic device having a battery fixing apparatus in accordance with an exemplary embodiment.

FIG. 2 is an exploded perspective view of the battery fixing apparatus of FIG. 1.

FIG. 3 is a partly exploded view of FIG. 1, showing one state of a battery fixed in the battery fixing apparatus.

FIG. 4 is an enlarged view of the circled portion IV of FIG. 3.

FIG. 5 is a partial, cross-sectional view taken along the line V-V of FIG. 1.

FIG. 6 is a partly exploded view of FIG. 1, showing another state of the battery unfixed from the battery fixing apparatus.

### DETAILED DESCRIPTION

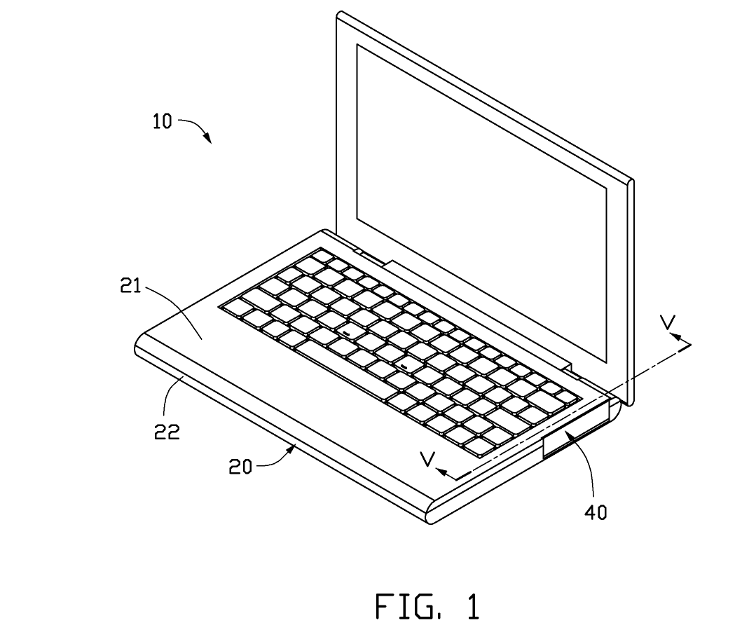

Referring to FIG. 1, an electronic device 10 includes a housing 20 and a battery fixing apparatus 40 mounted in the housing 20. The electronic device 10 can be, for example, a mobile phone, an e-reader, a PDA, a notebook computer, or the like. In the exemplary embodiment, the electronic device 10 is a notebook computer. The housing 20 is a base shell of the notebook computer, which includes a first enclosure 21 and a second enclosure 22 engaged with the first enclosure 21.

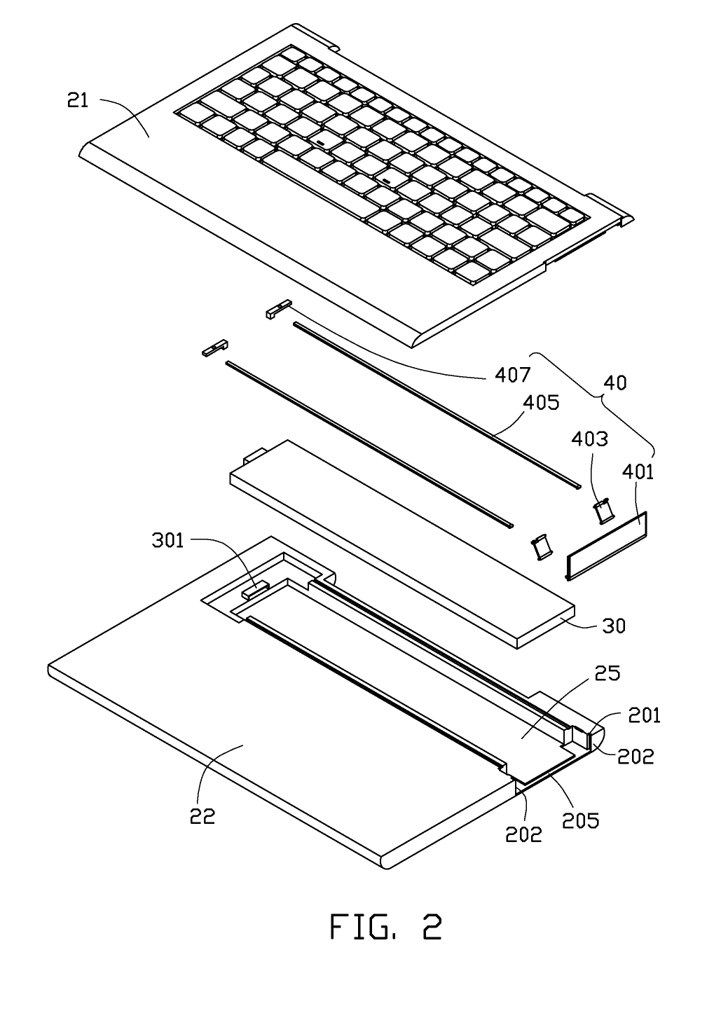

As shown in FIG. 2, a substantially rectangular compartment 25 is defined in the housing 20 for accommodating a battery 30. The compartment 25 has an opening 205 defined in a sidewall of the housing 20. A pair of inner walls 202 is disposed on each of the two sides of the opening 205. An electrode connector 301 is mounted at an end of the compartment 25 opposite to the opening 205.

Further referring to FIG. 2, the battery fixing apparatus 40 includes a cover 401, a pair of transmission bars 405, a pair of connecting portions 403 connecting the cover 401 with the transmission bars 405, and a pair of rotary portions 407.

The cover 401 is slidably disposed in the opening 205. In this embodiment, the cover 401, which is configured for closing the opening 205, is slidably received in a pair of slide-grooves 201 defined in the inner walls 202, once the battery 30 is accommodated in the compartment 25.

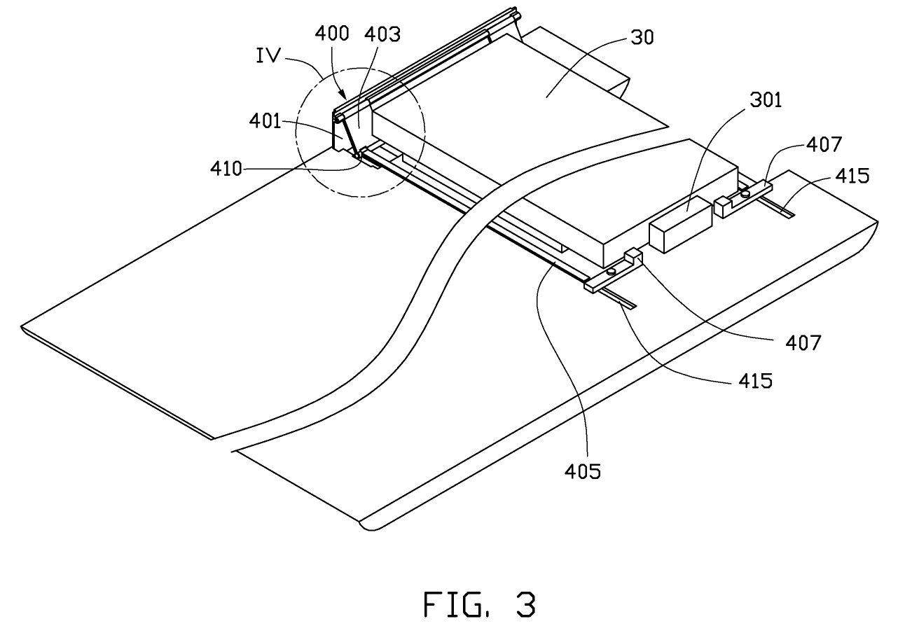

Referring to FIG. 3, one end of each of the connecting portion 403 is connected to the cover 401 via a first hinge 400; the other end of the connecting portion 403 is connected to one end of one of the transmission bar 405 via a second hinge 410. The housing 20 defines a pair of guide grooves 415 respectively adjacent to two sides of the compartment 25. Each of the transmission bars 405 is slidably received in one of the guide grooves 415. The rotary portions 407 are rotatablely mounted in the compartment 25 distal from the opening 205. In the exemplary embodiment, the rotary portions 407 are disposed respectively adjacent to the two sides of the electrode connector 301.

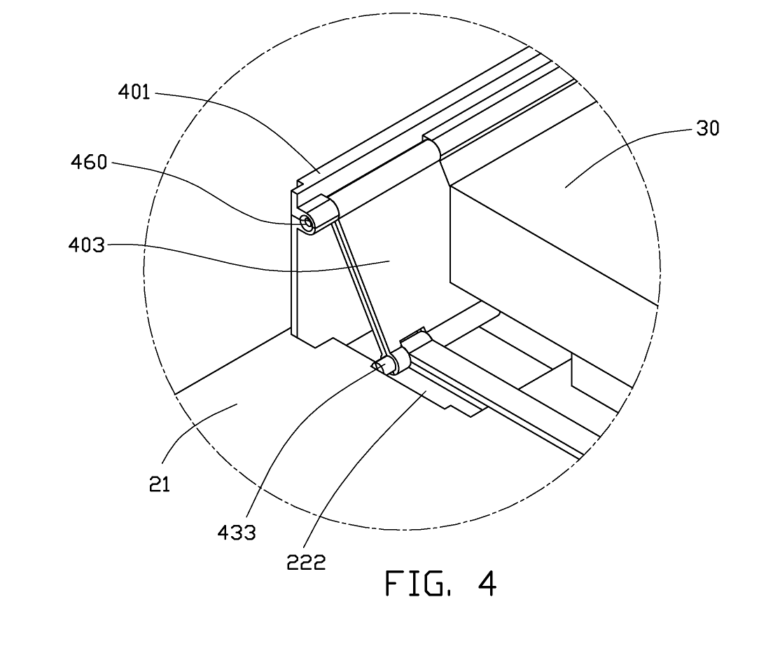

Referring to FIG. 4, a pair of guide channels 222 are next to the opening 205, and are defined in the edge of the compartment 25. Axis 433 of the second hinge 410 fit in the guide channels 222, and enable the second hinge 410 to slide along the guide channel 222.

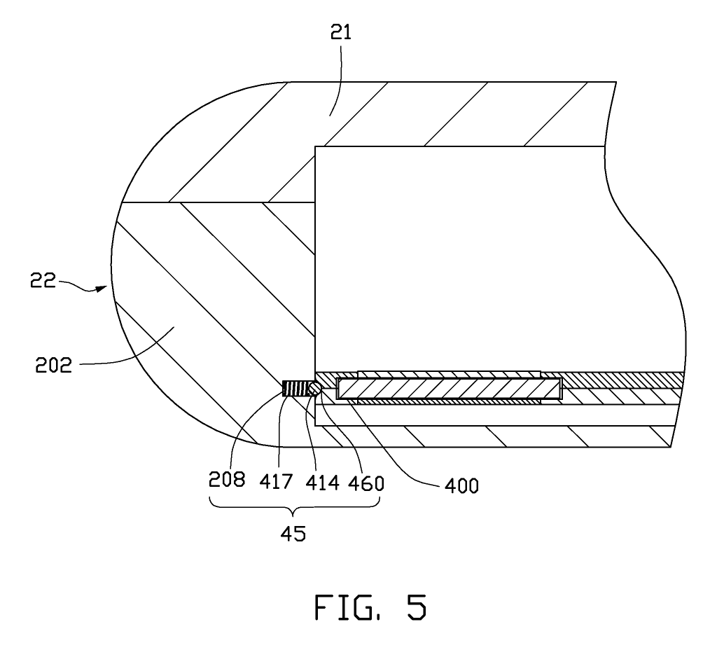

Referring to FIG. 5, the battery fixing apparatus 40 further includes a locking module 45 configured for locking the cover 401 at the opening 205 when the cover 401 closes the opening 205. In the exemplary embodiment, the locking module 45 includes a pair of pinholes 460 defined in two ends of the axis of the first hinge 400, a pair of receiving holes 208 defined in the inner walls 202, a pair of springs 417, and a pair of balls 414. Two ends of the springs 417 are fixed in the receiving holes 208 and the balls 414 respectively. The balls 414 compress the springs 417. When the cover 401 closes the opening 205, the receiving holes 208 are aligned with the pinholes 460, the springs 417 recover and push the balls 414 to enter into the pinholes 460, thus locking the cover 401.

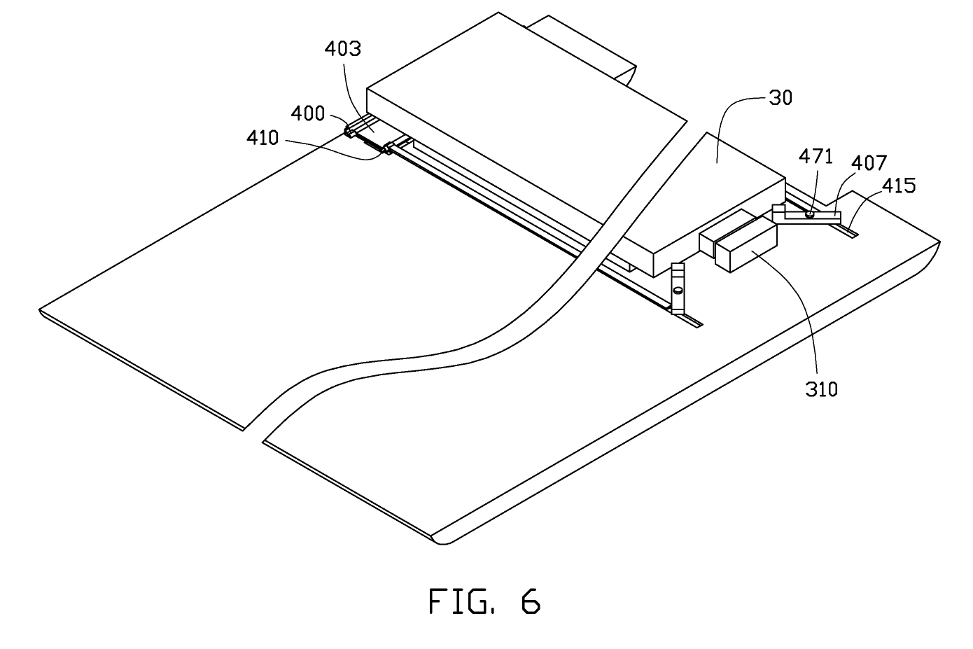

To fix the battery 30 in the electronic device 10, first, pull the cover 401 to open the opening 205; second, insert the battery 30 into the compartment 25 through the opening 205 (as show in FIG. 6); finally, push the cover 401 to close the opening 205. As the cover 401 moves along the slide-groove 201 to close the opening 205, the connecting portions 403 are driven to arch in the opening 205. A repelling force from the connecting portion 403 is applied to the battery 30, which makes the electrode of the battery 30 to contact with the electrode connector 301 (as show in FIG. 3). Further referring to FIG. 5, parts of the balls 414 are pushed into the pinholes 460 by the springs 417 to lock the cover 401. In this way, the battery 30 is fixed in the electronic device 10.

Referring to FIG. 3, to take out the battery 30 from the electronic device 10, pull the cover 401 to open the opening 205. Further referring to FIG. 5, when the cover 401 moves along the slide-groove 201, the balls 414 are extruded out of the pinholes 460 and compress the spring 417. The cover 401 drives the connecting portions 403 to lie low in the opening 205 via the first hinge 400. Then the connecting portions 403 push the transmission bars 405 to move away from the opening 20 via the second hinge 410, the transmission bars 405 drive the rotary portions 407 to rotate, the rotary portions 407 push the battery 301 to the opening 205. As a result, the electrode of the battery 30 disconnects from the electrode connector 301, and one end of the battery 30 moves out of the compartment 25 through the opening 205.

It is understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device comprising:
a housing defining a compartment therein, the compartment having an opening defined in one sidewall of the housing;
an electrode connector mounted on an end of the compartment opposite to the opening; and
a battery fixing apparatus configured for fixing a battery in the compartment, comprising:
a cover slidably disposed in the opening;
a connecting portion pivotably connected to the cover;
a transmission bar pivotably connected to the connecting portion; and
a rotary portion rotatablely mounted on the bottom surface of the housing within the compartment;
wherein when the cover closes the opening, the connecting portion is driven by the cover to arch and push the battery, and an electrode of the battery connects to the electrode connector; and when the cover opens the opening, the connecting portion is driven by the cover to push the transmission bar, the rotary portion is pushed by the transmission bar to rotate, and the rotary portion pushes the battery to eject from the compartment via the opening.

2. The electronic device as claimed in claim 1, further comprising a locking module, wherein the locking module comprises a pinhole defined in the cover, a receiving hole defined in each inner wall on two sides of the opening, a ball, and a spring fixed in the receiving hole and compressed by the ball; wherein when the cover closes the opening, the receiving hole is aligned with the pinhole, the spring drives the ball enter into the pinhole, thus locking the cover.

3. The electronic device as claimed in claim 1, wherein the housing comprises a first enclosure and a second enclosure engaged with the first enclosure.

4. The electronic device as claimed in claim 1, further comprising a first hinge for pivotably connecting the connecting portion to the cover, wherein the housing further defines a guide channel in the edge of the compartment, an axis of the first hinge fits in the guide channel and enables the first hinge to slide along the guide channel.

5. The electronic device as claimed in claim 1, wherein the housing further defines a guide groove adjacent to one side of the compartment, the transmission bar is slidably received in the guide groove.

6. The electronic device as claimed in claim 1, wherein the rotary portion is disposed adjacent to the electrode connector.

7. The electronic device as claimed in claim 1, further comprising a second hinge for pivotably connecting the connecting portion to the transmission bar.

8. A battery fixing apparatus for fixing a battery in a housing of an electronic device, comprising:
a compartment defined in the housing, the compartment having an opening defined in one sidewall of the housing;
a cover slidably disposed in the opening;
a connecting portion pivotably connected to the cover;
a transmission bar pivotably connected to the connecting portion; and
a rotary portion rotatablely mounted on the bottom surface of the housing within the compartment;
wherein when the cover closes the opening, the connecting portion is driven by the cover to arch and push the battery, and the electrode of an battery connects to the electrode connector; and when the cover opens the opening, the connecting portion is driven by the cover to push the transmission bar, the rotary portion is pushed by the transmission bar to rotate, and the rotary portion pushes the battery to eject from the compartment via the opening.

9. The battery fixing apparatus as claimed in claim 8, further comprising a locking module, wherein the locking module comprises a pinhole defined in the cover, a receiving hole defined in each inner wall disposed on two sides of the opening, a ball, and a spring fixed in the receiving hole and compressed by the ball; wherein when the cover closes the opening, the receiving hole is aligned with the pinhole, the spring drives the ball enter into the pinhole, thus locking the cover.

10. The battery fixing apparatus as claimed in claim 8, wherein the housing comprises a first enclosure and a second enclosure engaged with the first enclosure.

11. The battery fixing apparatus as claimed in claim 8, further comprising a first hinge for pivotably connecting the connecting portion to the cover, wherein the housing further defines a guide channel in the edge of the compartment, an axis of the first hinge fits in the guide channel and enables the first hinge to slide along the guide channel.

12. The battery fixing apparatus as claimed in claim 8, wherein the housing further comprising an electrode connector is mounted on an end of the compartment at the opposite to the opening; wherein the electrode connector is configured for contacting to the battery electrode when the cover closes the opening.

13. The battery fixing apparatus as claimed in claim 12, wherein the rotary portion is disposed adjacent to the electrode connector.

14. The battery fixing apparatus as claimed in claim 8, wherein the housing further defines a guide groove adjacent to one side of the compartment, the transmission bar is slidably received in the guide groove.

15. The battery fixing apparatus as claimed in claim 8, further comprising a second hinge for pivotably connecting the connecting portion to the transmission bar.
